(19) United States
(12) Patent Application Publication
(10) Pub. No.: US 2022/0243519 A1
(43) Pub. Date: Aug. 4, 2022

(54) POWER WINDOW DEVICE

(71) Applicants: Atsushi FUJITA, Aichi (JP); Katsunori KIGOSHI, Aichi (JP); So FUJIOKA, Aichi (JP); Tatsuki NAGATA, Aichi (JP); Yuki YAMAMOTO, Aichi (JP); Masahiko HARA, Aichi (JP)

(72) Inventors: Atsushi FUJITA, Aichi (JP); Katsunori KIGOSHI, Aichi (JP); So FUJIOKA, Aichi (JP); Tatsuki NAGATA, Aichi (JP); Yuki YAMAMOTO, Aichi (JP); Masahiko HARA, Aichi (JP)

(73) Assignee: NIDEC MOBILITY CORPORATION, Aichi (JP)

(21) Appl. No.: 17/586,810

(22) Filed: Jan. 28, 2022

(30) Foreign Application Priority Data
Jan. 29, 2021 (JP) 2021-012944

(51) Int. Cl. E05F 15/72; H02P 23/24; E05F 15/695; E05F 15/697; E05F 15/79

(52) U.S. Cl. CPC E05F 15/72; H02P 23/24; E05F 15/695; E05F 15/697; E05F 15/79; E05Y 2900/55; E05Y 2400/40; E05Y 2400/445; E05Y 2400/52; E05Y 2800/252; E05Y 2201/434

(57) ABSTRACT

A power window device includes a control unit configured to monitor a first potential at one end of a first switch circuit including a window closing switch and a second potential at one end of a second switch circuit including a window opening switch, and determine that submersion has occurred when the first or second potential is in a first or second submersion potential range. During a normal time, the control unit outputs a window closing command signal when the first potential is a potential at a time of the window closing switch being operated, and outputs a window opening command signal when the second potential is a potential at a time of the window opening switch being operated. At a time of submersion, the control unit does not output the window closing command signal, and outputs the window opening command signal.

### CROSS-REFERENCE TO RELATED APPLICATIONS

This application is based upon and claims the benefit of priority from Japanese Patent Application No. 2021-012944 filed on Jan. 29, 2021, the entire contents of which are incorporated herein by reference.

### FIELD

One or more embodiments of the present invention relate to a power window device that opens and closes a window by a motor, and more particularly to a technology for preventing the window from closing due to an error in switch operation when a vehicle is submerged.

### BACKGROUND

A power window device mounted on a vehicle is a device that rotates a motor forward or reversely according to an operation state of a switch, and opens and closes a window via an opening/closing mechanism provided between the motor and the window. When the switch is operated to an UP (window closing) side, the motor rotates forward to close the window, and when the switch is operated to a DOWN (window opening) side, the motor rotates reversely to open the window. The forward and reverse rotation of the motor is controlled by switching a direction of a current flowing through the motor.

Even in a case where the vehicle is submerged and the window opening/closing control cannot be performed normally, the power window device has a function that can detect submersion, and forcibly open the window by an operation of a switch to enable escape from the window and ensure the safety of an occupant. In JP-A-2018-100507, JP-B2-6634351, JP-A-2018-135726, JP-A-2019-015115, and JP-A-2020-087834, a power window device with such a submersion detection function is described.

In the power window device described in JP-A-2018-100507, JP-B2-6634351, JP-A-2018-135726, and JP-A-2019-015115, a detection pad (electrode) for detecting submersion is provided so that the number of components increases and the circuit configuration becomes complicated. On the other hand, in the power window device described in JP-A-2020-087834, based on a comparison result between a voltage of a terminal and a predetermined threshold value when a constant current passes through an input terminal, a submerged state is determined without providing the detection pad. According to the power window device of JP-A-2020-087834, the detection pad is unnecessary and the constant current circuit is required, so that a circuit configuration is inevitably complicated.

In addition, when the window is closed by an erroneous switch operation when the vehicle is submerged, the window is closed and the occupant is difficult to escape, thereby threatening the safety of the occupant. Therefore, measures for that are also required. For example, in JP-A-2018-100507, there is provided a first switching element that turns on when the detection pad is short-circuited when the vehicle is submerged, and a second switching element that turns on when the first switching element turns on. When submersion is detected and each switching element turns on, one end of the window closing switch on a power supply side is grounded by the second switching element. Therefore, even if the window closing switch is operated, no current flows through the switch and the switch operation is not detected, so that it is possible to prevent the window from being erroneously closed when the vehicle is submerged. However, in order to realize this function, a switching element such as a transistor or a relay is required in addition to the detection pad, so that the circuit configuration becomes more complicated.

### SUMMARY

One or more embodiments of the invention are provided to realize a power window device having high safety and reliability while having a simple circuit configuration.

A power window device according to one or more embodiments of the present invention includes an operation unit including a window closing switch that is operated to close a window and a window opening switch that is operated to open the window; a motor drive unit that drives a motor to open and close the window; and a control unit that controls an operation of the motor drive unit based on an operation of each switch of the operation unit. The operation unit includes a first switch circuit connected between a first power supply and a ground, the first switch circuit including a series circuit of the window closing switch and a resistor, and a second switch circuit connected between a second power supply and the ground, the second switch circuit including the window opening switch. The control unit is configured to monitor each of a first potential at one end of the first switch circuit on a first power supply side and a second potential at one end of the second switch circuit on a second power supply side and determine that submersion has occurred when the first potential is in a preset first submersion potential range or when the second potential is in a preset second submersion potential range. During a normal time when there is no submersion, the control unit outputs a window closing command signal for giving an instruction to close the window to the motor drive unit when the first potential is a potential at a time of the window closing switch being operated, and outputs a window opening command signal for giving an instruction to open the window to the motor drive unit when the second potential is a potential at a time of the window opening switch being operated. On the other hand, at a time of submersion in which submersion occurs, the control unit does not output the window closing command signal to the motor drive unit even when the first potential is the potential at the time of the window closing switch being operated, and outputs the window opening command signal to the motor drive unit when the second potential is the potential at the time of the window opening switch being operated.

According to the configuration, the first potential and the second potential at each one end of the first switch circuit and the second switch circuit are monitored by the control unit. At the time of submersion in which the first potential is in a first submersion potential range or the second potential is in a second submersion potential range, it is possible to open the window based on the window opening command signal output from the control unit when the window opening switch is operated. On the other hand, even if the window closing switch is erroneously operated at the time of submersion, the window closing command signal is not output from the control unit, so that it is possible to avoid a situation where the window is closed and safety is threatened. Therefore, even if a detection pad for submersion detection, a constant current circuit, and a switching element for prohibiting window closing at the time of submersion are not provided, it is possible to open the window and realize a highly safe power window device that can prevent the window from being erroneously closed at the time of submersion by a simple circuit configuration. Further, even when one of the first potential and the second potential is not in the submersion potential range, if the other is in the submersion potential range, it is determined that submersion has occurred, so that the reliability of submersion detection is improved. In addition, since submersion is detected by two systems of the first switch circuit and the second switch circuit, even if a malfunction occurs in one of the two switch circuits, submersion can be detected by the other switch circuit, and reliability is further improved.

In one or more embodiments of the present invention, with respect to the first potential, a first submersion threshold value for determining presence or absence of submersion and a window closing threshold value for determining presence or absence of an operation of the window closing switch may be set in the control unit, and with respect to the second potential, a second submersion threshold value for determining presence or absence of submersion and a window opening threshold value for determining presence or absence of an operation of the window opening switch may be set in the control unit. In this case, the first submersion potential range may be a range between the first submersion threshold value and the window closing threshold value, and the second submersion potential range may be a range between the second submersion threshold value and the window opening threshold value.

In one or more embodiments of the present invention, when the control unit determines that submersion has occurred based on the first submersion threshold value or the second submersion threshold value, the control unit may not determine presence or absence of an operation of the window closing switch based on the window closing threshold value, and may only determine presence or absence of an operation of the window opening switch based on the window opening threshold value.

In one or more embodiments of the present invention, the first submersion threshold value may be larger than the window closing threshold value, the second submersion threshold value may be larger than the window opening threshold value, and the window opening threshold value may be smaller than the window closing threshold value.

In one or more embodiments of the present invention, the window closing switch may include a manual closing switch for manually closing the window and an auto-closing switch for automatically closing the window, the window opening switch may include a manual opening switch for manually opening the window and an auto-opening switch for automatically opening the window, and the resistor may include a first voltage dividing resistor, a second voltage dividing resistor, and a third voltage dividing resistor. In this case, the first switch circuit may include the auto-opening switch, the auto-closing switch, the manual closing switch, the first voltage dividing resistor, the second voltage dividing resistor, and the third voltage dividing resistor, and the second switch circuit may include the manual opening switch. In the first switch circuit, a series circuit of the manual closing switch, the first voltage dividing resistor, the second voltage dividing resistor, and the third voltage dividing resistor, a series circuit of the auto-closing switch, the first voltage dividing resistor, and the second voltage dividing resistor, and a series circuit of the auto-opening switch and the first voltage dividing resistor may be connected between the first power supply and the ground. In the second switch circuit, the manual opening switch may be connected between the second power supply and the ground.

In one or more embodiments of the present invention, the operation unit may include a first terminal to which the one end of the first switch circuit is connected and a second terminal to which the one end of the second switch circuit is connected. Further, the control unit may include a third terminal connected to the first terminal by a first wiring and a fourth terminal connected to the second terminal by a second wiring. Further, the third terminal may be connected to the first power supply via a first pull-up resistor, and the fourth terminal may be connected to the second power supply via a second pull-up resistor. The control unit may monitor a potential at the third terminal as the first potential and monitor a potential at the fourth terminal as the second potential.

According to one or more embodiments of the present invention, it is possible to realize a power window device having high safety and reliability while having a simple circuit configuration.

### BRIEF DESCRIPTION OF DRAWINGS

FIG. 1 is a circuit diagram illustrating a first embodiment of the present invention;

FIG. 2 is a diagram for explaining a determination threshold value used in a normal time;

FIG. 3 is a diagram for explaining a determination threshold value used at a time of submersion;

FIG. 4 is a diagram illustrating a potential at one end of each switch circuit at a normal time;

FIG. 5 is a diagram illustrating a potential at one end of each switch circuit at the time of submersion;

FIG. 6 is a circuit diagram illustrating a second embodiment of the present invention; and

FIG. 7 is a circuit diagram illustrating a third embodiment of the present invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

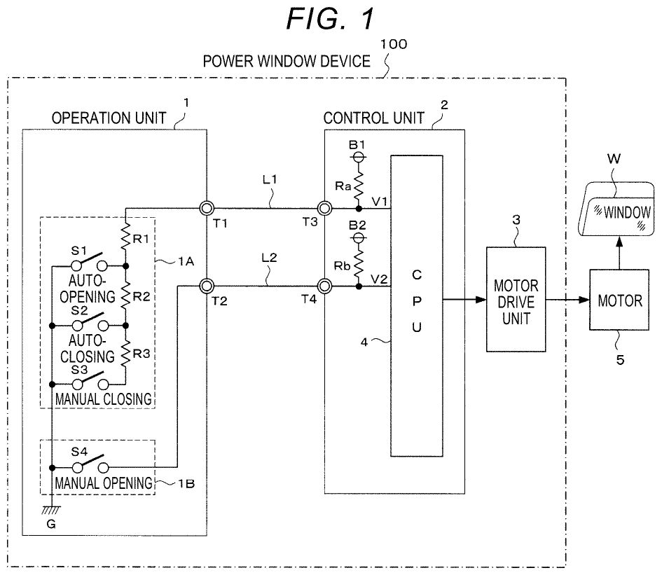

Embodiments of the present invention will be described with reference to the drawings. FIG. 1 illustrates a power window device according to a first embodiment. A power window device 100 includes an operation unit 1, a control unit 2, and a motor drive unit 3.

The operation unit 1 is provided with a switch circuit 1A (first switch circuit), a switch circuit 1B (second switch circuit), a terminal T1 (first terminal), and a terminal T2 (second terminal). One end of the switch circuit 1A is connected to the terminal T1, and the other end of the switch circuit 1A is connected to a ground G. Further, one end of the switch circuit 1B is connected to the terminal T2, and the other end of the switch circuit 1B is connected to the ground G.

The control unit 2 is provided with a CPU 4, a pull-up resistor Ra (first pull-up resistor), a pull-up resistor Rb (second pull-up resistor), a terminal T3 (third terminal), and a terminal T4 (fourth terminal). One end of the pull-up resistor Ra is connected to a power supply B1 (first power supply), and the other end of the pull-up resistor Ra is connected to the terminal T3. One end of the pull-up resistor Rb is connected to the power supply B2 (second power supply), and the other end of the pull-up resistor Rb is connected to the terminal T4. Although the power supply B1 and the power supply B2 are distinguished here, they may be the same power supply. Hereinafter, a voltage of the power supply B1 is referred to as B1 for convenience, and a voltage of the power supply B2 is referred to as B2 for convenience.

The terminal T1 of the operation unit 1 is connected to the terminal T3 of the control unit 2 by a wiring L1 (first wiring). Further, the terminal T2 of the operation unit 1 is connected to the terminal T4 of the control unit 2 by a wiring L2 (second wiring).

In the operation unit 1, the switch circuit 1A has switches S1 to S3 and resistors R1 to R3. The switch S1 is an auto-opening switch for automatically opening the window, and the switch S2 is an auto-closing switch for automatically closing the window. The switch S3 is a manual closing switch for manually closing the window. The resistors R1 to R3 are voltage dividing resistors connected in series. As an example, the resistance values of the pull-up resistor Ra and the voltage dividing resistors R1 to R3 are selected such that R2<R3<R1<Ra. The resistance values of the pull-up resistor Ra and the pull-up resistor Rb may be the same or different.

The switch circuit TB has a switch S4. The switch S4 is a manual opening switch for manually opening the window. The auto-opening switch S1 and the manual opening switch S4 are examples of the “window opening switch” in one or more embodiments of the present invention, and the auto-closing switch S2 and the manual closing switch S3 are examples of the “window closing switch” in one or more embodiments of the present invention.

In the case of the auto-opening switch S1, the window opening operation continues even if the operation is released after the operation, whereas in the case of the manual opening switch S4, the window opening operation is performed only while the operation state is held, and when the operation is released, the window opening operation is stopped. Further, in the case of the auto-closing switch S2, the window closing operation is continued even if the operation is released after the operation, whereas in the case of the manual closing switch S3, the window is closed only while the operation state is held, and when the operation is released, the window closing operation is stopped.

In the switch circuit 1A, a series circuit of the manual closing switch S3, the resistor R1 (first voltage dividing resistor), the resistor R2 (second voltage dividing resistor), and the resistor R3 (third voltage dividing resistor) is connected between the terminal T1 and the ground G. Further, a series circuit of the auto-closing switch S2, the resistor R1, and the resistor R2 is connected between the terminal T1 and the ground G. Further, a series circuit of the auto-opening switch S1 and the resistor R1 is connected between the terminal T1 and the ground G. The terminal T1 is connected to the power supply B1 via the wiring L1, the terminal T3, and the pull-up resistor Ra.

In the switch circuit 1B, the manual opening switch S4 is connected between the terminal T2 and the ground G. The terminal T2 is connected to the power supply B2 via the wiring L2, the terminal T4, and the pull-up resistor Rb.

In the control unit 2, an input side of the CPU 4 is connected to a connection point between the pull-up resistor Ra and the terminal T3, and a connection point between the pull-up resistor Rb and the terminal T4. The CPU 4 monitors a potential V1 (first potential) of the terminal T3 and a potential V2 (second potential) of the terminal T4, and controls the motor drive unit 3 based on a result thereof (details will be described later).

The motor drive unit 3 is configured of a known circuit including a PWM circuit that generates a pulse width modulation (PWM) signal, a switching circuit that performs a switching operation by the PWM signal, and the like.

In the present embodiment, the motor 5 is configured of a DC motor and rotates at a predetermined speed based on a drive voltage output from the motor drive unit 3. In the operation unit 1, when the auto-closing switch S2 or the manual closing switch S3 is operated, a window closing command signal for giving an instruction to close of the window is output from the control unit 2 (CPU 4), and the motor 5 rotates forward and the window W closes based on this command signal. Further, in the operation unit 1, when the auto-opening switch S1 or the manual opening switch S4 is operated, a window opening command signal for giving an instruction to open of the window is output from the control unit 2 (CPU 4), and the motor 5 rotates reversely and the window W opens based on this command signal. An opening/closing mechanism (not illustrated) is provided between the motor 5 and the window W.

Although not illustrated in FIG. 1, the control unit 2 performs feedback control for the motor drive unit 3 such that the rotation speed of the motor 5 is set as a target speed based on an output of a sensor (rotary encoder or the like) that detects the rotation speed of the motor 5.

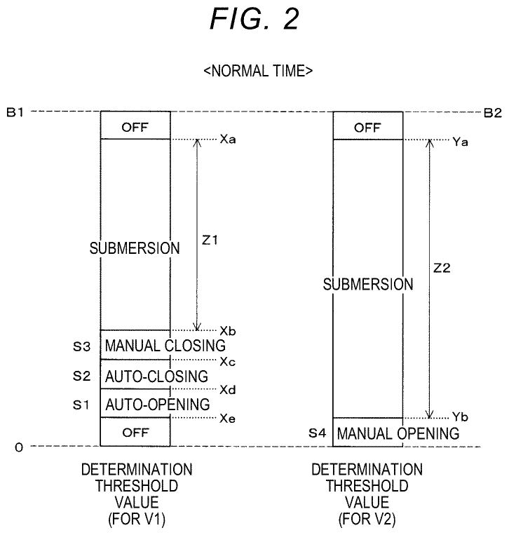

Next, submersion detection, which is a feature of one or more embodiments of the invention, will be described in detail with reference to FIGS. 2 to 5.

As described above, the CPU 4 of the control unit 2 monitors the potential V1 of the terminal T3 and the potential V2 of the terminal T4. Since the terminals T3 and T4 are connected to the terminals T1 and T2, respectively, the potential V1 is a potential at one end of the switch circuit 1A on a power supply B1 side, and the potential V2 is a potential at one end of the switch circuit 1B on a power supply B2 side. With respect to these potentials V1 and V2, a threshold value for determining the presence or absence of the operation of the switches S1 to S4 and a threshold value for determining the presence or absence of submersion are set in the control unit 2. Each threshold value is stored in advance in an internal memory (not illustrated) built in the CPU 4 or an external memory (not illustrated) provided separately from the CPU 4.

FIG. 2 illustrates a determination threshold value used at the normal time (when not submerged). Here, five threshold values Xa to Xe are set between the power supply voltage B1 and zero volt with respect to the potential V1, and two threshold values Ya and Yb are set between the power supply voltage B2 and zero volt with respect to the potential V2. The power supply voltages B1 and B2 have the same value.

Of the threshold values set for the potential V1, Xa is a first submersion threshold value for determining the presence or absence of submersion. Xb is a window closing threshold value for determining that the manual closing switch S3 has been operated. Xc is a window closing threshold value for determining that the auto-closing switch S2 has been operated. Xd is a window opening threshold value for determining that the auto-opening switch S1 has been operated. Xe is an OFF threshold value indicating that the operation of each of the switches S1 to S3 is not determined. A region Z1 (Xa≥Z1>Xb) between Xa and Xb indicates the first submersion potential range.

The CPU 4 compares the potential V1 with each of the threshold values Xa to Xe, and if Xa≥V1>Xb (that is, if V1 is in the first submersion potential range Z1), it is determined that submersion has occurred. Further, the CPU 4 determines that the manual closing switch S3 has been operated if Xb≥V1>Xc, determines that the auto-closing switch S2 has been operated if Xc≥V1>Xd, determined that the auto-opening switch S1 has been operated if Xd≥V1>Xe, and does not determine that the switch has been operated if Xe≥V1≥0.

Further, among the threshold values set for the potential V2, Ya is the second submersion threshold value for determining the presence or absence of submersion, and Yb is the window opening threshold value for determining that the manual opening switch S4 has been operated. A region Z2 (Ya≥Z2>Yb) between Ya and Yb indicates the second submersion potential range. The second submersion threshold value Ya is substantially the same as the first submersion threshold value Xa (Ya≈Xa), and the window opening threshold value Yb is smaller than the window closing threshold value Xb (Yb<Xb).

The CPU 4 compares the potential V2 with each of the threshold values Ya and Yb, and determines that submersion has occurred if Ya≥V2>Yb (that is, if V2 is in the second submersion potential range Z2). Further, the CPU 4 determines that the manual opening switch S4 has been operated if Yb≥V2≥0.

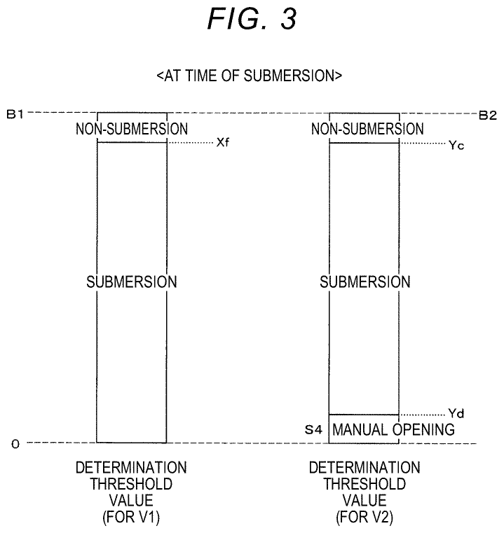

FIG. 3 illustrates a determination threshold value used at the time of submersion in which the power window device 100 is in the submerged state. At the time of submersion, only the threshold value Xf is set between the power supply voltage B1 and zero volt with respect to the potential V1. The threshold value Xf is a first submersion threshold value similar to the normal threshold value Xa in FIG. 2. On the other hand, for the potential V2, two threshold values Yc and Yd are set between the power supply voltage B2 and zero volt. The threshold value Yc is a second submersion threshold value similar to the normal threshold value Ya in FIG. 2. Further, the threshold value Yd is a window opening threshold value similar to the normal threshold value Yb in FIG. 2. The second submersion threshold value Yc is substantially the same as the first submersion threshold value Xf (Yc≈Xf).

In FIGS. 2 and 3, the first submersion threshold values Xa and Xf may be the same value or different values. Further, Ya and Yc, which are the second submersion threshold values, may be the same value or different values. Further, the window opening threshold values Yb and Yd may be the same value or may be different values.

In the normal state, the CPU 4 of the control unit 2 determines the presence or absence of the operation of the switches S1 to S4 as described above based on the comparison result between the potentials V1 and V2, and each threshold value in FIG. 2, and determines the presence or absence of submersion. Then, in a case where it is determined that submersion has occurred, the CPU 4 determines the presence or absence of the switch operation and the presence or absence of submersion by using the determination threshold value of FIG. 3 instead of the determination threshold value of FIG. 2.

In FIG. 3, the potentials V1 and V2 are in the range of Xf≥V1≥0 and Yc≥V2≥Yd, respectively, while the submerged state continues. At this time, regarding the potential V1, the determination of the presence or absence of the operation of the auto-opening switch S1, the auto-closing switch S2, and the manual closing switch S3 is not performed, and only determination of the presence or absence of the operation of the manual opening switch S4 is performed based on the comparison between the potential V2 and the threshold value Yd. Then, in a case where it is determined that the manual opening switch S4 has been operated (Yd≥V2≥0), the CPU 4 outputs a window opening command signal for manually opening the window W to the motor drive unit 3.

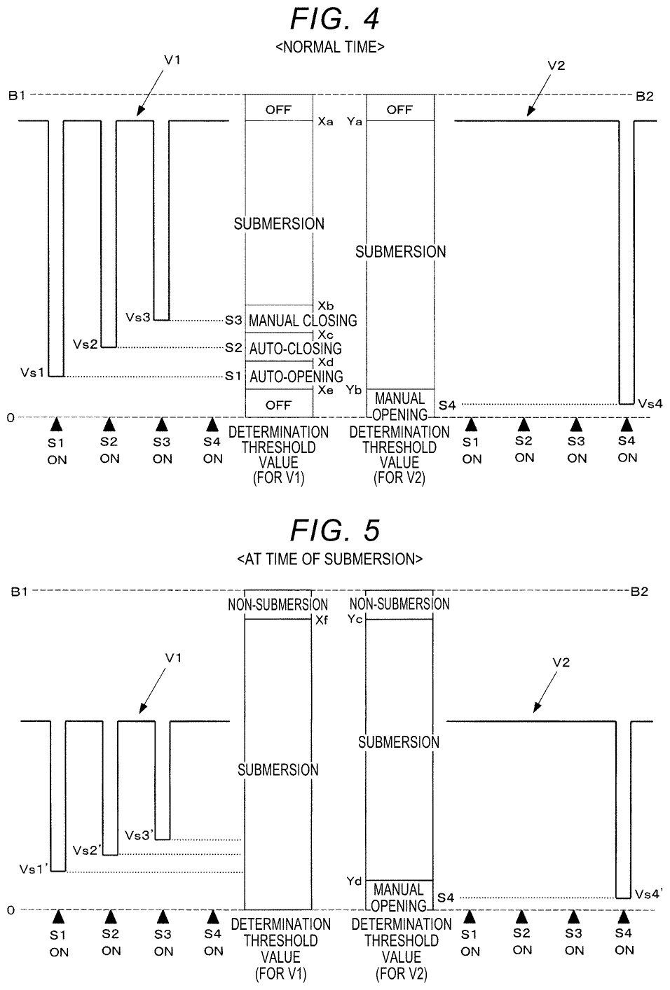

FIG. 4 illustrates a state of a change in the potentials V1 and V2 based on the operation of each of the switches S1 to S4 at the normal time. Since the potential V1 is the potential at the terminal T3, the potential V1 changes when the switches S1 to S3 connected to the terminal T3 are turned on, and the potential V1 does not change when the switch S4 not connected to the terminal T3 is turned on. On the other hand, since the potential V2 is the potential at the terminal T4, the potential V2 changes when the switch S4 connected to the terminal T4 is turned on, and the potential V2 does not change when the switches S1 to S3 not connected to the terminal T4 are turned on.

In FIG. 4, when none of the switches S1 to S4 is operated, the potentials V1 and V2 are B1≥V1>Xa and B2≥V2>Ya, respectively (off state). Now, when the auto-opening switch S1 is operated and turned on, the potential V1 drops to Vs1. From FIG. 1, Vs1 at this time is obtained as follows:

Vs1=B1·R1/(Ra+R1)

For convenience, the resistance in the switch S1 and the wiring L1 is ignored (the same applies to Vs2, Vs3, and Vs1′ to Vs3′ described later). If Vs1 is in the range of Xd≥Vs1>Xe, the CPU 4 determines that the auto-opening switch S1 has been operated, and outputs the window opening command signal for giving an instruction to automatically open of the window W to the motor drive unit 3.

Further, when the auto-closing switch S2 is operated and turned on, the potential V1 drops to Vs2. From FIG. 1, Vs2 at this time is obtained as follows:

Vs2=B1·(R1+R2)/(Ra+R1+R2)

If Vs2 is in the range of Xc≥Vs2>Xd, the CPU 4 determines that the auto-closing switch S2 has been operated, and outputs the window closing command signal instructing the automatic closing of the window W to the motor drive unit 3.

Further, when the manual closing switch S3 is operated and turned on, the potential V1 drops to Vs3. From FIG. 1, Vs3 at this time is obtained as follows:

Vs3=B1·(R1+R2+R3)/(Ra+R1+R2+R3)

If Vs3 is in the range of Xb≥Vs3>Xc, the CPU 4 determines that the manual closing switch S3 has been operated, and outputs the window closing command signal for giving an instruction to manually close of the window W to the motor drive unit 3.

On the other hand, when the manual opening switch S4 is operated and turned on, the potential V2 drops to Vs4. From FIG. 1, Vs4 at this time is obtained as follows:

Vs4=B2·Rx/(Rb+Rx)

where the total resistance of the switch S4, the wiring L2, and the like is Rx. Here, since Rx is a sufficiently smaller value than Rb (Rb>>Rx), Vs4 is also a smaller value than the above-mentioned Vs1 to Vs3. If Vs4 is in the range of Yb≥Vs4≥0, the CPU 4 determines that the manual opening switch S4 has been operated, and outputs the window opening command signal for giving an instruction to manually open of the window W to the motor drive unit 3.

FIG. 5 illustrates a state of a change in the potentials V1 and V2 based on the operation of each of the switches S1 to S4 at the time of submersion. The operation unit 1 and the control unit 2 illustrated in FIG. 1 have a waterproof structure in which water does not enter into the inside thereof. When the operation unit 1 and the control unit 2 are submerged, electric leakage occurs in the terminals T1 to T4 exposed to the outside. Since the current flowing through the switch circuits 1A and 1B decreases, the potentials V1 and V2 become lower than that at the normal time.

In FIG. 5, in a case where none of the switches S1 to S4 is operated, the potentials V1 and V2 are Xf≥V1≥0 and Yc≥V2≥Yd, respectively (submerged state). In this state, when the auto-opening switch S1 is operated and turned on, the potential V1 drops to Vs1′, and when the auto-closing switch S2 is operated and turned on, the potential V1 drops to Vs2′ and when the manual closing switch S3 is operated and turned on, the potential V1 drops to Vs3′. However, since no threshold value is set for these switches S1 to S3, the presence or absence of the operation is not determined. That is, in the submerged state, the operation of each of the switches S1 to S3 is ignored. Therefore, at the time of submersion, even if the potential V1 is the potentials Vs2′ and Vs3′ when the auto-closing switch S2 and the manual closing switch S3 are operated, the window closing command signal is not output from the CPU 4 to the motor drive unit 3, and the window W does not close.

On the other hand, when the manual opening switch S4 is operated and turned on in the submerged state, the potential V2 drops to Vs4′. Since the threshold value Yd is set for the switch S4, if Yd≥Vs4′≥0, the CPU 4 determines that the manual opening switch S4 has been operated, and outputs the window opening command signal instructing the manual opening of the window W to the motor drive unit 3.

Therefore, at the time of submersion, the window W can be forcibly opened and escaped by operating the manual opening switch S4. Further, even if the auto-closing switch S2 or the manual closing switch S3 is operated at the time of submersion, those operations are ignored, so that it is possible to avoid a situation where the window W is closed and the occupant cannot escape.

When the submerged state is released, the electric leakage at the terminals T1 to T4 disappears, so that the current flowing through the switch circuits 1A and 1B increases and the potentials V1 and V2 rise, and in FIG. 5, B1≥V1>Xf or B2≥V2>Yc. At this time, the CPU 4 determines that the state has changed from the submerged state to the non-submerged state, and switches the determination threshold value in FIG. 3 to the determination threshold value in FIG. 2. Therefore, the processing based on the above-mentioned normal determination threshold value is performed.

According to the above-described embodiment, the potentials V1 and V2 at each one end of the switch circuits 1A and 1B are monitored by the CPU 4, and at the time of submersion when the potential V1 is in the submersion potential range Z1 or the potential V2 is in the submersion potential range Z2, if the manual opening switch S4 is operated, the window W can be opened based on the window opening command signal output from the CPU 4. On the other hand, even if the auto-closing switch S2 or the manual closing switch S3 is erroneously operated at the time of submersion, the window closing command signal is not output from the CPU 4, so that it is possible to avoid a situation where the window W is closed and safety is threatened. Therefore, without providing a detection pad for submersion detection (JP-A-2018-100507, JP-B2-6634351, JP-A-2018-135726, and JP-A-2019-015115), a constant current circuit (JP-A-2020-087834), a switching element for prohibiting window closing at the time of submersion (JP-A-2018-100507), or the like, it is possible to open the window W and realize the high safe power window device 100 that can prevent the window W from being erroneously closed at the time of submersion by a simple circuit configuration.

Further, even in a case where one of the potentials V1 and V2 is not in the submersion potential ranges Z1 and Z2, if the other is in the submersion potential ranges Z1 and Z2, it is determined that submersion has occurred. Therefore, even if an electric leakage occurs in the terminals T1 and T3, the potential V2 enters the submersion potential range Z2 if there is electric leakage at the terminals T2 and T4, so that it is possible to determine that submersion has occurred, and the reliability of submersion detection is improved. In addition, since submersion is detected by two systems of the switch circuit 1A and the switch circuit 1B, even if a malfunction such as failure, disconnection, or poor contact occurs in one switch circuit, submersion can be detected by the other switch circuit, and reliability is further improved. Furthermore, a power window device with a submersion detection function and a power window device without a submersion detection function can be realized by a same circuit board assembly only by changing a software program of the CPU 4, so that the product numbers can be shared to facilitate management.

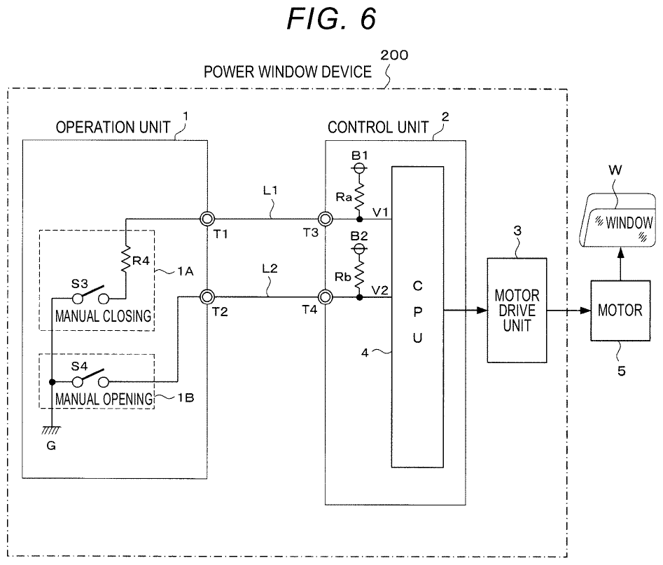

FIG. 6 illustrates a power window device 200 according to a second embodiment of the present invention. FIG. 6 is different from FIG. 1 in that the switch circuit 1A is configured of only a series circuit of the manual closing switch S3 and the voltage dividing resistor R4. The configuration of the switch circuit 1B is the same as that of FIG. 1, and the other configurations are also the same as those of FIG. 1.

That is, in the second embodiment, in the switch circuit 1A of FIG. 1, the auto-opening switch S1 and the auto-closing switch S2 are excluded, and the resistors R1 to R3 are replaced with the resistors R4. In the second embodiment, the threshold values Xc and Xd in FIG. 2 are omitted. Even with such a second embodiment, the same effect as that of the first embodiment can be obtained.

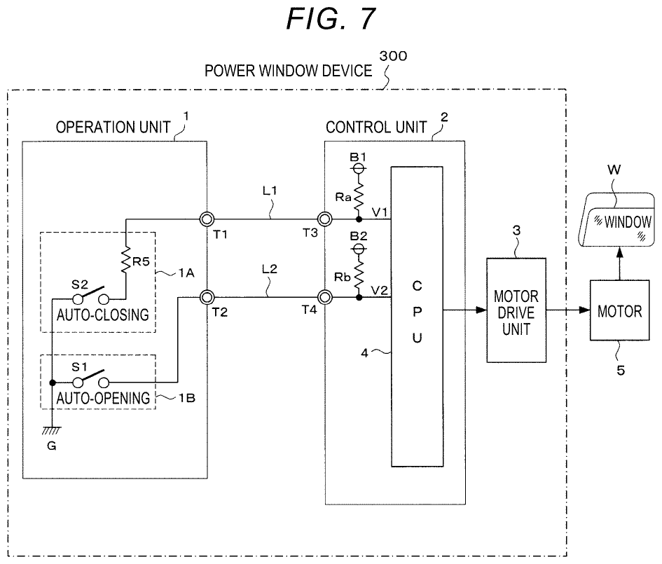

FIG. 7 illustrates a power window device 300 according to a third embodiment of the present invention. FIG. 7 is different from FIG. 1 in that the switch circuit 1A is configured of only a series circuit of the auto-closing switch S2 and the voltage dividing resistor R5, and the switch circuit 1B is configured of the auto-opening switch S1. Other configurations are the same as those in FIG. 1.

That is, in the third embodiment, in the switch circuit 1A of FIG. 1, the auto-opening switch S1, the manual closing switch S3, and the resistor R3 are excluded, the resistors R1 and R2 are replaced with the resistors R5, and in the switch circuit 1B of FIG. 1, the manual opening switch S4 is replaced with the auto-opening switch S1. In the third embodiment, the threshold values Xb and Xd in FIG. 2 are omitted, and the threshold value Yb becomes the threshold value of the auto-opening switch S1. With such a third embodiment, the same effects as those of the first and second embodiments can be obtained.

In the present invention, various embodiments can be adopted in addition to the above-described embodiments.

For example, in the above-described embodiments, an example is given in which the pull-up resistors Ra and Rb are provided in the control unit 2, but these pull-up resistors Ra and Rb may be provided in the operation unit 1.

Further, in the above-described embodiments, an example is given in which the motor drive unit 3 is provided separately from the control unit 2, but the motor drive unit 3 may be incorporated into the control unit 2.

Further, in the above-described embodiments, an example is given in which the motor 5 is provided outside the power window devices 100, 200, and 300, but the motor 5 may be provided in the power window devices 100, 200, and 300.

Further, in the above-described embodiments, an example is given in which the power window devices 100, 200, and 300 are provided for a vehicle, but the present invention can also be applied to power window devices used in fields other than the vehicle.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A power window device comprising:
an operation unit comprising a window closing switch that is operated to close a window and a window opening switch that is operated to open the window;
a motor drive unit that drives a motor to open and close the window; and
a control unit that controls an operation of the motor drive unit based on an operation of each switch of the operation unit,
wherein the operation unit comprises:
a first switch circuit connected between a first power supply and a ground, the first switch circuit comprising a series circuit of the window closing switch and a resistor, and
a second switch circuit connected between a second power supply and the ground, the second switch circuit comprising the window opening switch,
wherein the control unit is configured to:
monitor each of a first potential at one end of the first switch circuit on a first power supply side and a second potential at one end of the second switch circuit on a second power supply side; and
determine that submersion has occurred when the first potential is in a preset first submersion potential range or when the second potential is in a preset second submersion potential range,
wherein during a normal time when there is no submersion, the control unit
outputs a window closing command signal for giving an instruction to close the window to the motor drive unit when the first potential is a potential at a time of the window closing switch being operated, and
outputs a window opening command signal for giving an instruction to open the window to the motor drive unit when the second potential is a potential at a time of the window opening switch being operated, and
wherein at a time of submersion in which submersion occurs, the control unit
does not output the window closing command signal to the motor drive unit even when the first potential is the potential at the time of the window closing switch being operated, and
outputs the window opening command signal to the motor drive unit when the second potential is the potential at the time of the window opening switch being operated.

2. The power window device according to claim 1,
wherein with respect to the first potential, a first submersion threshold value for determining presence or absence of submersion and a window closing threshold value for determining presence or absence of an operation of the window closing switch are set in the control unit,
wherein with respect to the second potential, a second submersion threshold value for determining presence or absence of submersion and a window opening threshold value for determining presence or absence of an operation of the window opening switch are set in the control unit,
wherein the first submersion potential range is a range between the first submersion threshold value and the window closing threshold value, and
wherein the second submersion potential range is a range between the second submersion threshold value and the window opening threshold value.

3. The power window device according to claim 2,
wherein when it is determined that submersion has occurred based on the first submersion threshold value or the second submersion threshold value, the control unit does not determine presence or absence of the operation of the window closing switch based on the window closing threshold value and only determines presence or absence of the operation of the window opening switch based on the window opening threshold value.

4. The power window device according to claim 2,
wherein the first submersion threshold value is larger than the window closing threshold value,
wherein the second submersion threshold value is larger than the window opening threshold value, and
wherein the window opening threshold value is smaller than the window closing threshold value.

5. The power window device according to claim 1,
wherein the window closing switch comprises a manual closing switch for manually closing the window and an auto-closing switch for automatically closing the window,
wherein the window opening switch comprises a manual opening switch for manually opening the window and an auto-opening switch for automatically opening the window,
wherein the resistor comprises a first voltage dividing resistor, a second voltage dividing resistor, and a third voltage dividing resistor,
wherein the first switch circuit comprises the auto-opening switch, the auto-closing switch, the manual closing switch, the first voltage dividing resistor, the second voltage dividing resistor, and the third voltage dividing resistor,
wherein the second switch circuit comprises the manual opening switch,
wherein in the first switch circuit, a series circuit of the manual closing switch, the first voltage dividing resistor, the second voltage dividing resistor, and the third voltage dividing resistor, a series circuit of the auto-closing switch, the first voltage dividing resistor, and the second voltage dividing resistor, and a series circuit of the auto-opening switch and the first voltage dividing resistor are connected between the first power supply and the ground, and
wherein in the second switch circuit, the manual opening switch is connected between the second power supply and the ground.

6. The power window device according to claim 1,
wherein the operation unit comprises a first terminal to which the one end of the first switch circuit is connected and a second terminal to which the one end of the second switch circuit is connected,
wherein the control unit comprises a third terminal connected to the first terminal by a first wiring and a fourth terminal connected to the second terminal by a second wiring,
wherein the third terminal is connected to the first power supply via a first pull-up resistor, and the fourth terminal is connected to the second power supply via a second pull-up resistor, and
wherein the control unit monitors a potential at the third terminal as the first potential and monitors a potential at the fourth terminal as the second potential.
